(19) United States
(12) Patent Application Publication
(10) Pub. No.: US 2025/0299317 A1
(43) Pub. Date: Sep. 25, 2025

(54) IMAGE INSPECTION DEVICE

(71) Applicant: Keyence Corporation, Osaka (JP)

(72) Inventors: Keisuke FUKUTA, Osaka (JP); Yuichiro HIDA, Osaka (JP)

(73) Assignee: Keyence Corporation, Osaka (JP)

(21) Appl. No.: 19/049,064

(22) Filed: Feb. 10, 2025

(30) Foreign Application Priority Data
Mar. 19, 2024 (JP) 2024-043895

(51) Int. Cl. G06T 7/00

(52) U.S. Cl. CPC G06T 7/0006; G06T 7/001; G06T 2207/20081

(57) ABSTRACT

An image inspection device includes an image capturing section that generate a plurality of frame images aligned in time series, an inspection execution section that outputs an inspection result, and an inspection setting section that performs setting of the inspection execution section. The inspection setting section receives setting of a window for a learning image on which the object appears The inspection execution section detects target regions from a first frame image and a second image based on the learning image and the window set for the learning image, performs matching processing of the target region between the first frame image and the second frame image based on the detected target regions from the first image frame and the second image frame, and an overall moving direction of the object, and counts the object based on a result of the matching processing.

### CROSS-REFERENCE TO RELATED APPLICATIONS

The present application claims foreign priority based on Japanese Patent Application No. 2024-043895, filed Mar. 19, 2024, the contents of which are incorporated herein by reference.

### BACKGROUND OF THE INVENTION

### 1. Technical Field

The present disclosure relates to an image inspection device.

### 2. Description of the Related Art

An image sensor of related art generally executes detection processing of an object on one frame image (see, for example, JP2022-164146A).

### SUMMARY OF THE INVENTION

Incidentally, the image sensor can be used to robustly detect an object presented by a user with respect to a change in an image characteristic of the object and count the object passing through a capturing field of view.

In a case where the object passing through the capturing field of view is counted by using the image sensor that executes verification processing of the object on one frame image as in JP2022-164146A, an output from the image sensor is input to a programmable logic controller [PLC], and the PLC needs to execute predetermined processing. Thus, programming in the PLC takes time and effort.

In addition, when an attempt is made to count the passage of the object detected by the image sensor based on the output (for example, ON or OFF) of the image sensor, it is necessary to increase a frame rate such that there is no capturing omission of an image capable of detecting the passing object.

Thus, even in a case where one object passes through, there is a plurality of frame images on which the object appears. That is, when the number of times of the ON output of the image sensor or the number of times of the ON output of the image sensor in a scan cycle of the PLC is simply counted, the same object may be redundantly counted.

In addition, in consideration of such circumstances, for example, even in a case where the output of the image sensor transitions from OFF→ON→OFF to determine one count, count duplication and count omission are not completely wiped out.

For example, when the output of the image sensor is correctly determined to be OFF→ON→ON→ON→OFF for five consecutive frame images in which one object appears, a count number becomes “1”. However, for example, when the output of the image sensor is erroneously determined to be OFF→ON→“OFF”→ON→OFF, the count number becomes “2”. This is a state where count duplication occurs.

In addition, for example, when the output of the image sensor is correctly determined to be “OFF→ON→OFF→ON→OFF” for five consecutive frame images in which two objects appear, the count number is “2”. However, for example, when the output of the image sensor is erroneously determined to be OFF→ON→“ON”→ON→OFF”, the count number becomes “1”. This is a state where count omission occurs. For example, in a case where a plurality of objects is aligned in a direction (vertical direction intersecting a traveling direction (horizontal direction), or in a case where the plurality of objects is close to each other, the plurality of objects may be counted as one object.

In view of the above problems, the present disclosure provides an image inspection device capable of counting an object with high accuracy.

For example, an image inspection device according to one embodiment includes an image capturing section that continuously captures a capturing field of view to generate a plurality of frame images aligned in time series, an inspection execution section that executes inspection processing of an object appearing in the plurality of frame images to output an inspection result, and an inspection setting section that performs setting of the inspection execution section. The inspection setting section receives setting of a window for a learning image on which the object appears, and the inspection execution section detects target regions from the plurality of frame images based on the learning image and the window set for the learning image, acquires first positional information of the target region detected in a first frame image and second positional information of the target region detected in a second frame image, performs matching processing of the target region between the first frame image and the second frame image based on the first positional information, the second positional information, and an overall moving direction of the object, and counts the object based on a result of the matching processing.

Note that, other characteristics, elements, steps, advantages, and features will be more apparent from the following detailed description and the accompanying drawings.

The image inspection device according to the invention can count the object with high accuracy.

### BRIEF DESCRIPTION OF THE DRAWINGS

FIG. 1 is a diagram for describing an image inspection device according to an embodiment of the invention at the time of an operation;

FIG. 2 is a hardware configuration diagram of the image inspection device;

FIG. 3 is a functional block diagram of the image inspection device;

FIG. 4 is a diagram illustrating a setting flow of a passage count tool;

FIG. 5 is a diagram illustrating a graphical user interface [GUI] transition of FIG. 4;

FIG. 6 is a diagram illustrating an execution flow of the passage count tool;

FIG. 7 is a conceptual diagram related to matching processing between frame images; and

FIG. 8 is a diagram illustrating GUI transition of additional learning.

### DETAILED DESCRIPTION

Hereinafter, embodiments of the invention will be described in detail with reference to the drawings. Note that, the following description of preferred embodiments is merely exemplary in nature and is not intended to limit the invention, an application thereof, or an intended use thereof.

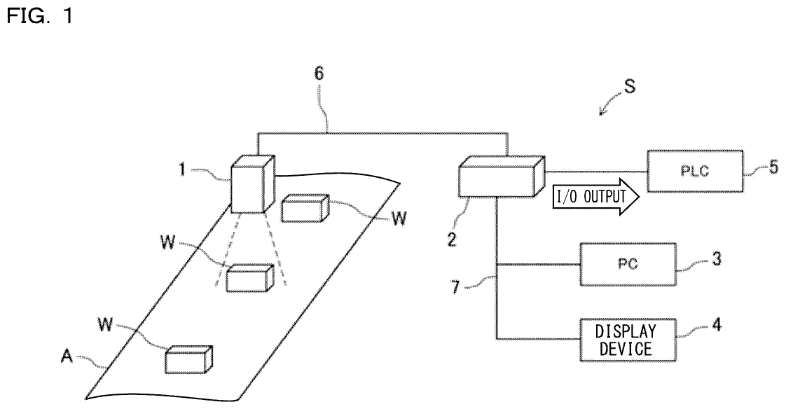

FIG. 1 is a diagram for describing an image inspection device S according to an embodiment of the invention at the time of an operation. For example, the image inspection device S captures workpieces W conveyed by a conveyance unit A according to capturing settings to acquire inference image data, detects the workpieces W in images of the acquired inference image data, and outputs a detection result to an external device. Examples of the external device include a programmable logic controller (PLC) 5 and the like, but a device other than the PLC 5 may be an external device. Based on the received detection result, the PLC 5 controls the conveyance unit A so as to separate storage destinations of the workpieces W, for example. In the following description, a case where the external device is the PLC 5 will be described. Note that, the workpiece W may be a workpiece that is not conveyed by the conveyance unit A. In addition, in the following description, the workpiece is also referred to as an object.

The image inspection device S includes an image capturing unit 1 for capturing an image of the workpiece W, a control unit 2 to which inference image data captured by the image capturing unit 1 is input, a personal computer (PC) 3 for performing settings and the like of the image inspection device S, and a display device 4 for displaying a setting screen, a selection screen, a workpiece image, a detection result, and the like. In the control unit 2, a trained model for detecting the workpiece W in the image of the input inference image data is executable. The control unit 2 executes an output corresponding to the detection result by the trained model for the PLC 5.

Here, the image inspection device S may be used, for example, when the workpiece W is inspected from various angles at each point of a manufacturing apparatus or a manufacturing line. Thus, a plurality of image inspection devices S may be installed in one manufacturing apparatus or one manufacturing line, and it is conceivable that an installation space and a power supply cannot be sufficiently secured. Accordingly, the image inspection device S needs miniaturization corresponding to the installation space and power saving corresponding to the power supply, and in order to satisfy these needs, the image inspection device S according to the present embodiment does not include a graphics processing unit (GPU). The control unit 2 executes a trained model in which machine learning is performed to such an extent that the workpiece W can be detected, but the image inspection device S is provided from a vendor to a user such that desired detection accuracy can be obtained even though the user does not perform advanced machine learning that is recommended to use the GPU. Details will be described later. Since the user does not need to perform advanced machine learning, the user can execute a trained model capable of detecting the workpiece W without preparing a GPU suitable for learning. In addition, a time taken by the user to prepare the trained model capable of detecting the workpiece W can be shortened. Note that, one image inspection device S may be installed and operated in a manufacturing apparatus or a manufacturing line. In addition, the image inspection device S can also be referred to as an image sensor.

### Configuration of Image Capturing Unit

The image capturing unit 1 is separate from the control unit 2, and is installed so as to be able to capture the workpiece W from a desired direction. The workpiece W is sequentially conveyed by the conveyance unit A to a capturing field of view of the image capturing unit 1.

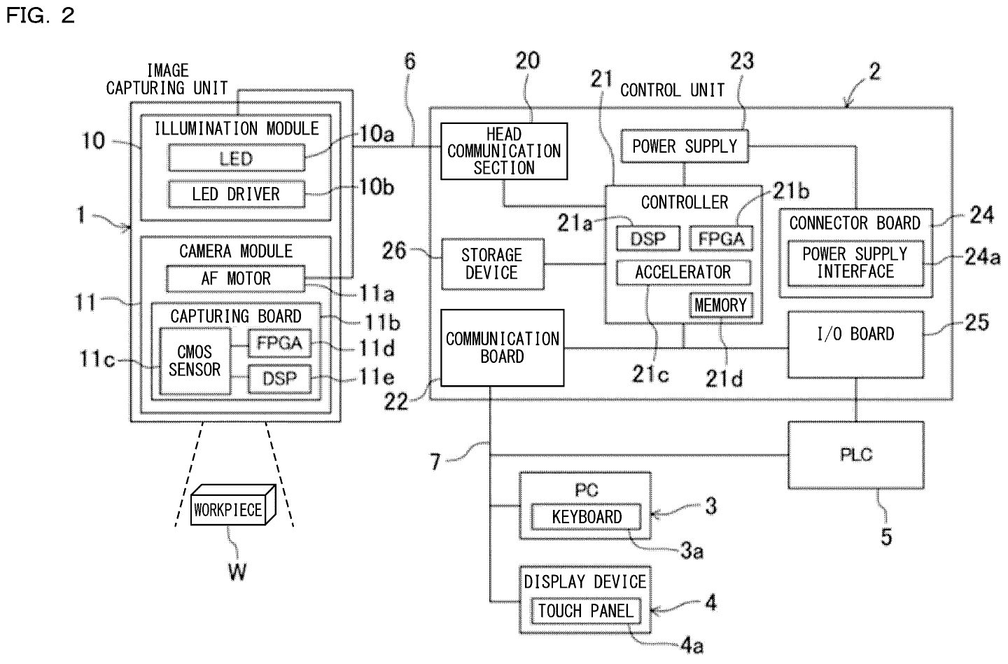

FIG. 2 is a hardware configuration diagram of the image inspection device S. As illustrated in FIG. 2, the image capturing unit 1 includes an illumination module 10 for illuminating the workpiece W and a camera module 11 for capturing an image of the workpiece W illuminated by the illumination module 10.

The illumination module 10 includes a light emitting diode (LED) 10a that irradiates the workpiece W with light, and an LED driver 10b that controls a light amount, a light emission timing, and the like of the LED 10a. The LED driver 10b is connected to a head communication section 20 (to be described later) of the control unit 2, and is controlled by a controller 21 (to be described later) of the control unit 2.

The camera module 11 includes an AF motor 11a and a capturing board 11b. The AF motor 11a is a member for automatically focusing on the workpiece W by driving a focusing lens of an optical system (not illustrated). The autofocusing method is not particularly limited, and examples thereof include a contrast method and the like.

The capturing board 11b includes a CMOS sensor 11c, an FPGA 11d, and a DSP 11c. The CMOS sensor 11c is an image sensor that receives reflected light emitted from the LED 10a to the workpiece W and reflected by the workpiece W. The CMOS sensor 11c is connected to the head communication section 20 of the control unit 2, and is controlled by the controller 21 of the control unit 2 to perform exposure processing at a predetermined timing for a predetermined time.

The FPGA 11d is a processing device capable of changing internal processing contents. The DSP 11e is a signal processing device. A light reception amount signal of a light receiving element included in the CMOS sensor 11c is output to the FPGA 11d and processed, and is also output to the DSP 11e and processed. The processing by the FPGA 11d and the DSP 11e is not particularly limited, and examples thereof include various kinds of filter processing. Image data processed by the FPGA 11d and the DSP 11e is transmitted from the image capturing unit 1 to the control unit 2.

The image capturing unit 1 and the control unit 2 are connected via a communication cable 6. Thus, the control unit 2 can be installed at a place away from an installation place of the image capturing unit 1.

### Configuration of PC

The PC 3 is constituted by a general-purpose personal computer or the like. In this example, the PC 3 can be used by installing a predetermined program in a personal computer. The PC 3 includes operation devices such as a keyboard 3a and a mouse (not illustrated). The user of the image inspection device S can perform a setting operation and a selection operation of the image inspection device S by operating the operation device of the PC 3. Specific setting operation and selection operation will be described later.

The PC 3 and the communication board 22 of the control unit 2 are connected to communicate with each other, and information based on the setting operation by the user is transmitted from the PC 3 to the control unit 2. In addition, the PC 3 can receive the image data of the workpiece W, the inspection result, and the like output from the control unit 2. The PC 3 and the control unit 2 are connected via a communication cable 7. Thus, the PC 3 can be installed at a place away from an installation place of the control unit 2.

### Configuration of Display Device 4

The display device 4 includes, for example, a liquid crystal display, an organic EL display, or the like. In this example, the display device 4 includes a touch panel 4a. The touch panel 4a is a member capable of detecting an operation by a user's finger. A type of the touch panel 4a is not particularly limited, and examples thereof include a capacitance type and an infrared type. The display device 4 and the communication board 22 of the control unit 2 are connected to communicated with each other. Operation information of the touch panel 4a by the user is transmitted from the display device 4 to the control unit 2. In addition, the display device 4 can receive image data and the like of the workpiece W output from the control unit 2. The display device 4 and the control unit 2 are connected via the communication cable 7. Thus, the display device 4 can be installed at a place away from the installation place of the control unit 2.

Note that, the PC 3 and the display device 4 may be integrally provided. For example, the display device 4 may be constituted by a display device included in the PC 3. In this case, a body portion of the PC 3 and the display device 4 may be integrated with each other or may be separated from each other. In addition, in this example, the communication board 22 and the PLC 5 are connected via the communication cable 7.

### Configuration of Control Unit 2

As illustrated in FIG. 2, the control unit 2 includes the head communication section 20, the controller 21, the communication board 22, a power supply 23, a connector board 24, an I/O board 25, and a storage device (storage section) 26. The head communication section 20 is a portion that is connected to the controller 21 and executes communication between the controller 21 and the image capturing unit 1. A control signal of the image capturing unit 1 output from the controller 21 is transmitted to the image capturing unit 1 via the head communication section 20. The control signal of the image capturing unit 1 includes a signal for controlling a light emission timing and a light emission amount of the LED 10a and a signal for controlling the AF motor 11a and the capturing board 11b. In addition, the image data acquired by the image capturing unit 1 is output from the image capturing unit 1 and is then transmitted to the controller 21 via the head communication section 20.

The controller 21 includes a DSP 21a and an FPGA 21b that execute various kinds of signal processing, an accelerator 21c for speeding up processing, and a memory 21d including a RAM, a ROM, and the like. A specific configuration of the controller 21 will be described later.

The communication board 22 is a member that is connected to the controller 21 and executes communication between the controller 21, the PC 3, the display device 4, and the PLC 5.

The connector board 24 includes a power supply interface 24a. A power cable (not illustrated) for supplying power from an outside is connected to the power supply interface 24a. The connector board 24 and the power supply 23 are connected, and power supplied from the outside to the power supply interface 24a is adjusted to a predetermined voltage by the power supply 23 and is then supplied to the controller 21. The power supplied to the controller 21 is supplied to the image capturing unit 1 via the head communication section 20.

The I/O board 25 is connected to the controller 21. The inspection result output from the controller 21 is input to the PLC 5 via the I/O board 25.

### Functional Block

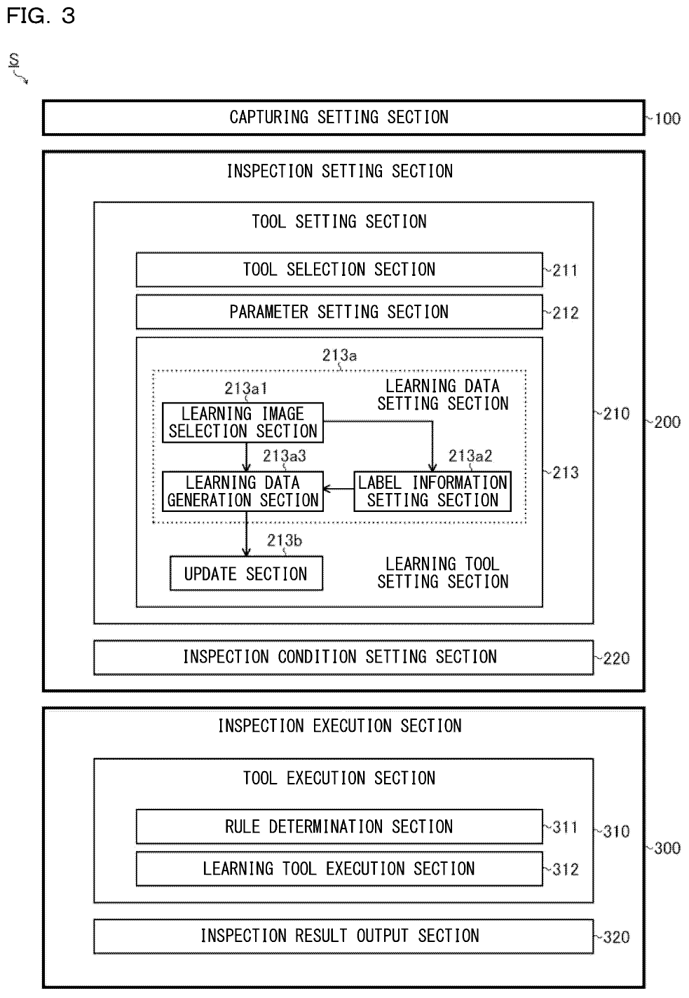

FIG. 3 is a functional block diagram of the image inspection device S. As illustrated in this drawing, the image inspection device S includes, as functional blocks thereof, a capturing setting section 100, an inspection setting section 200, and an inspection execution section 300.

The capturing setting section 100 performs various settings (capturing field of view, brightness of image, focus, capturing interval (frame rate), and the like) regarding a capturing operation of the image capturing unit 1. Note that, the image capturing unit 1 can be understood as an image capturing section that continuously captures the capturing field of view to generate a plurality of frame images FR aligned in time series.

The inspection setting section 200 performs various settings regarding the inspection of the frame image FR by the inspection execution section 300. In accordance with this drawing, the inspection setting section 200 includes a tool setting section 210 and an inspection condition setting section 220.

The tool setting section 210 sets various tools. In accordance with this drawing, the tool setting section 210 includes a tool selection section 211, a parameter setting section 212, and a learning tool setting section 213.

The tool selection section 211 selects a tool to be set and a tool to be used.

The parameter setting section 212 sets a rule-based tool. In the rule-based tool, the inspection is performed based on various feature amounts (contour, color, position, and the like) of the workpiece W appearing in the image.

The learning tool setting section 213 sets a tool of a learning system using a machine learning model. In the tool of the learning system, a trained model such as a discriminator is generated according to the teaching of the user, and the inspection is performed based on an output from the trained model. In accordance with this drawing, the learning tool setting section 213 includes a learning data setting section 213a and an update section 213b. The machine learning model may include a neural network.

The learning data setting section 213a sets learning data to be input to the machine learning model. The learning data includes a learning image and a teaching content. The learning image includes, for example, at least one of a non-defective product image and a defective product image. The teaching content includes label information such as “this image is a non-defective product”, “this image is a defective product” and “this portion is defective”. The label information includes information corresponding to a class into which the workpiece W is to be classified. In accordance with this drawing, the learning data setting section 213a includes a learning image selection section 213a1, a label information setting section 213a2, and a learning data generation section 213a3.

The learning image selection section 213a1 selects a learning image. For example, the learning image selection section 213a1 may have a function of presenting a learning recommendation image at the time of setting a passage count tool. Details will be described later.

The label information setting section 213a2 receives label information for displaying the learning image selected by the learning image selection section 213a1 on the GUI and using the learning image as learning data. For example, at the time of setting the passage count tool, the label information setting section 213a2 receives window setting for the learning image on which the workpiece W appears.

The learning data generation section 213a3 generates learning data based on the learning image selected by the learning image selection section 213a1 and the window setting received by the label information setting section 213a2. For example, the learning data generation section 213a3 stores an image characteristic of the workpiece W based on the setting of the window.

The update section 213b updates parameters of the machine learning model such that the output of the machine learning model approaches an expected value according to the teaching content. The updating of the parameter may be understood as learning of the machine learning model. However, the learning of the machine learning model does not necessarily need to be performed by the user in all processes. For example, learning with a relatively large calculation amount may be completed on a vendor side before shipment of the image inspection device S, and only learning with a relatively small calculation amount may be performed on the user side before operation of the image inspection device S. In the present specification, learning performed by the vendor side before shipment is referred to as pre-shipment learning, and learning performed by the user before operation of the image inspection device S is referred to as customer learning.

For example, the machine learning model of the image inspection device S may include a feature extraction section in which customer learning is not performed and a determination section in which customer learning is performed. Note that, the characteristic extraction section extracts a feature amount from the image. In addition, the determination section outputs an inspection result from the feature amount.

That is, the machine learning model of the image inspection device S may include a parameter fixed portion. The parameter fixed portion is a layer in which a parameter obtained by pre-shipment learning on the vendor side is fixed, in other words, a layer in which customer learning on the user side is unnecessary. In addition, the machine learning model of the image inspection device S may include a segmentation model that facilitates customer learning on the user side.

With this configuration, it is not necessary for the user to prepare, for example, the GPU as a facility with high processing capability required for deep learning, or for the vendor to provide an advanced learning environment by the GPU or the like as a cloud service (SaaS or the like). Therefore, an introduction barrier of the image inspection device S is lowered.

As described above, the learning should be understood in a broad sense as not only referring to deep learning with a large calculation amount but also including learning with a small calculation amount, that is, the customer learning in the present specification. Note that, since the customer learning is learning with a small calculation amount, the machine learning model may be trained by a method that does not include a machine learning method.

The inspection condition setting section 220 determines an output condition of the image inspection device S, in other words, a condition of the sensor output, for example, by combining a plurality of tools.

The inspection execution section 300 executes inspection processing of the workpiece W appearing in the plurality of frame images FR and outputs the inspection result. In accordance with this drawing, the inspection execution section 300 includes a tool execution section 310 and an inspection result output section 320.

The tool execution section 310 executes a tool selected as a use target by the tool selection section 211. In accordance with this drawing, the tool execution section 310 includes a rule determination section 311 and a learning tool execution section 312.

In a case where the tool selection section 211 selects a rule-based tool as the use target, the rule determination section 311 executes the rule-based tool.

In a case where the tool selection section 211 selects the tool of the learning system as the use target, the learning tool execution section 312 executes the tool of the learning system.

The inspection result output section 320 outputs the inspection result according to the output condition set by the inspection condition setting section 220. The inspection may include image classification, abnormality detection, region segmentation, and the like.

Each of the capturing setting section 100, the inspection setting section 200, and the inspection execution section 300 may be constituted only by hardware, or may be constituted by a combination of hardware and software. In addition, each of the capturing setting section 100, the inspection setting section 200, and the inspection execution section 300 may be independent, or may be configured such that a plurality of functions is realized by one piece of hardware or software. Note that, the software can be executed by the control unit 2 (in particular, the controller 21) in which a program file and a setting file are installed.

The image inspection device S of the present configuration example can be switched between a setting mode and a driving mode. In the setting mode, for example, various parameter settings such as capturing settings, registration of a master image, and generation (learning) of a discriminator that identifies an image are performed. The identification of the image as used herein includes identification related to whether the image is a non-defective product image or a defective product image, and the image inspection device S may be configured to perform quality determination as to whether or not the workpiece W is a non-defective product or a defective product based on the identification result. In addition, in the setting mode, for example, a preliminary work for enabling the user to separate the non-defective product and the defective product in a desired product inspection is performed.

In the driving mode, the workpiece W is inspected based on the frame image FR captured at an actual site. The inspection of the workpiece W includes a number count for counting the number of workpieces W in addition to the above-described quality determination. The switching between the setting mode and the driving mode can be performed on a GUI to be described later. In addition, it is also possible to configure to automatically shift to the driving mode simultaneously with finish of the setting mode. In the driving mode, it is also possible to perform correction or change of an identification boundary by the discriminator, that is, so-called additional learning.

### Passage Mode

Incidentally, the image inspection device S includes, as one of various modes, a passage mode for detecting the workpiece W sequentially passing through the capturing field of view of the image capturing unit 1. That is, a mode for performing time-series processing independently of a mode for performing one determination on one frame image is prepared in the image inspection device S. In the passage mode, a passage count tool can be set and driven as a tool for detecting a plurality of workpieces W sequentially passing through the capturing field of view of the image capturing unit I and counting the number of the workpieces W.

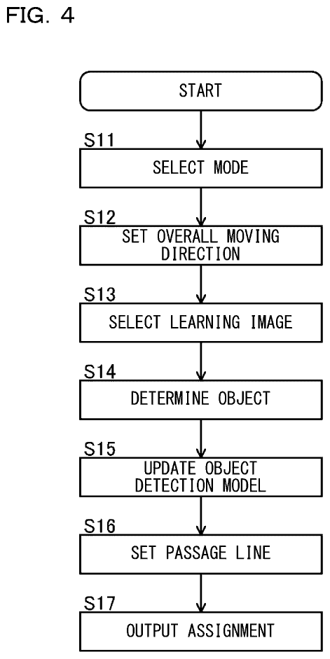

FIG. 4 is a diagram illustrating a setting flow of the passage count tool. Note that, an execution subject of this flow can be basically understood as the inspection setting section 200.

When this flow is started, one mode is selected from a plurality of modes (for example, standard mode, sorting mode, and passage mode) in step S11. In the present embodiment, since only the passage count tool can be set in the passage mode, the passage count tool may be selected instead of the passage mode. The following description is based on the assumption that the passage mode is selected in this step. In step S12, an overall moving direction Wd of the workpiece W is set. The overall moving direction Wd corresponds to a conveyance direction of the conveyance unit A (for example, a conveyor). In step S13, at least one learning image is selected from the plurality of frame images FR. In step S14, a target region is determined from the learning image. Specifically, the workpiece W appearing in the learning image is designated as a target region (ROI [region of interest]) by setting the window. In step S15, an object detection model which is one of machine learning models is updated such that the target region is detected from the learning image. In step S16, a passage line of the workpiece W is set. The passage line can be understood as a division line for dividing a detection range of the workpiece W into a pre-passage region and a post-passage region. In step S17, the output of the inspection result is assigned to a plurality of output ports.

Note that, since the passage count tool according to the present embodiment detects the target region by the object detection model obtained by the machine learning, this flow (particularly, steps S12 to S14) includes selection of the learning image (step S12) and the like. However, the target region is not limited to detection by the object detection model, and may be detected on a rule basis. In a case where the image inspection device S detects the target region on the rule basis, for example, instead of steps S12 to S14, the image inspection device S may be configured to receive an input of a feature amount (contour, color, position, or the like) necessary for detecting the workpiece W and store the feature amount.

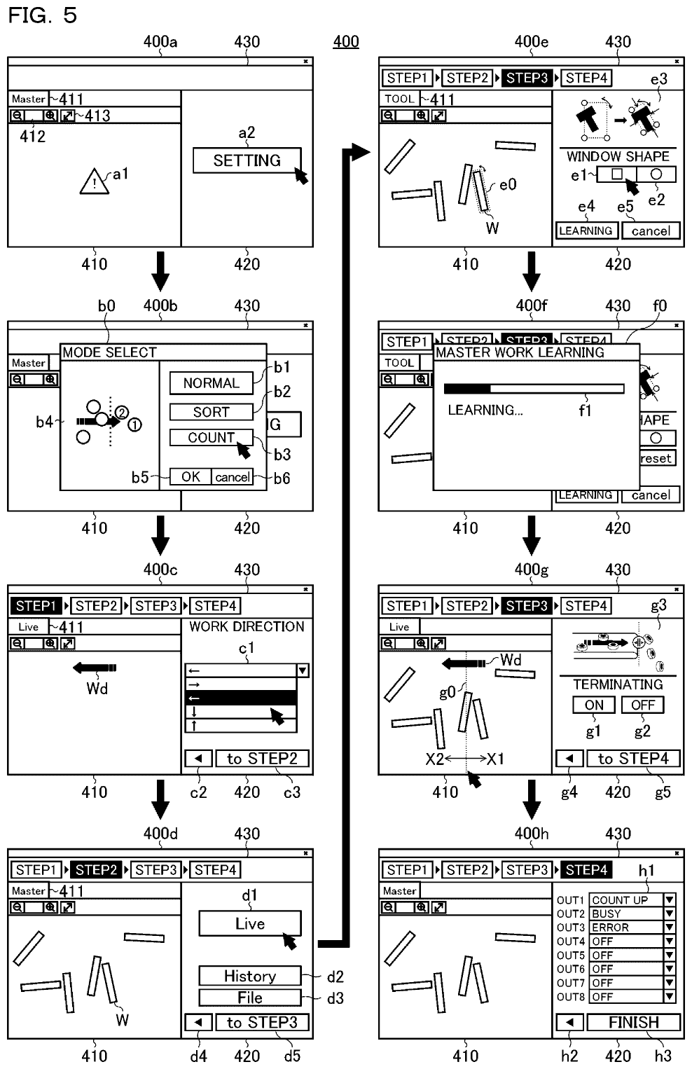

FIG. 5 is a diagram illustrating GUI transition corresponding to the setting flow illustrated in FIG. 4. When an image inspection program is executed by the PC 3, a GUI 400 (=various screens 400a to 400i) is displayed on the display device 4. The GUI 400 includes, as a basic layout, an image display region 410, an operation region 420, and a progress display region 430.

In the image display region 410, the frame image FR captured by the image capturing unit 1 and the like are displayed. In addition, the image display region 410 may be accompanied by a state display banner 411, an enlargement and reduction button 412, a maximum display button 413, and the like. In the state display banner 411, an operation state (status) of the image inspection program is briefly displayed. The enlargement and reduction button 412 and the maximum display button 413 are operated when the image displayed in the image display region 410 is enlarged or reduced and maximized, respectively.

When the image inspection device S is activated for the first time, an initial activation screen 400a (a first row in a left column) is displayed. Note that, at the time of the first activation of the image inspection device S, the image inspection program cannot be set. Thus, an alert mark a1 (or alert message) indicating that a master image is unregistered may be displayed in the image display region 410. In addition, a banner (for example, “Master”) indicating that the master image is unregistered (or is being registered) may be displayed on the state display banner 411.

In addition, for example, a setting start button a2 is displayed in the operation region 420 of the initial activation screen 400a. When the setting start button a2 is clicked (or tapped, and the same applies later), setting of the image inspection program is started. This start corresponds to the start of the setting flow illustrated in FIG. 4.

In the setting of the image inspection program, first, a mode selection screen 400b (a second row in the left column) is displayed. The mode selection screen 400b corresponds to step S11 in FIG. 4. For example, as illustrated in this drawing, a mode selection dialog b0 may be displayed on the mode selection screen 400b.

In the mode selection dialog b0, for example, a standard mode button b1, a sorting mode button b2, a passage mode button b3, a guidance b4, an OK button b5, and a cancel button b6 are displayed.

When the standard mode button b1 is clicked, the standard mode is selected. In the standard mode, the non-defective product or the defective product of the workpiece W is identified. When the sorting mode button b2 is clicked, the sorting mode is selected. In the sorting mode, the workpieces W are sorted (classified) into a plurality of classes. When the passage mode button b3 is clicked, the passage mode is selected. In the passage mode, the number of workpieces W sequentially passing through the capturing field of view of the image capturing unit 1 is counted. In the guidance b4, an outline and a schematic diagram of the mode selected by clicking among the standard mode button b1, the sorting mode button b2, and the passage mode button b3 may be displayed.

When the OK button b5 is clicked, a selection state of the mode is confirmed. On the other hand, when the cancel button b6 is clicked, the selection state of the mode is canceled and the mode selection dialog b0 is closed. The following description is based on the assumption that the passage mode is selected on the mode selection screen 400b (mode selection dialog b0).

When the passage mode is selected on the mode selection screen 400b, a first process (capturing setting), a second process (master registration), a third process (tool setting), and a fourth process (output assignment) are sequentially advanced as a setting work of the passage mode. Thereafter, in the progress display region 430 described above, each process may be displayed on a flowchart, and the process currently being executed may be highlighted. With such a configuration, the user can grasp a progress status of the setting work at a glance.

First, in the first process (capturing setting), a moving direction setting screen 400c (a third row in the left column) is displayed. The moving direction setting screen 400c corresponds to step S12 in FIG. 4. For example, a pull-down menu c1, a back button c2, and a forward button c3 may be displayed in the operation region 420 of the moving direction setting screen 400c.

In the pull-down menu c1, a plurality of candidates (for example, four directions of “from left to right”, “from right to left”, “from top to bottom”, and “from bottom to top”) are displayed as the overall moving direction Wd of the workpiece W. In this drawing, “from right to left” is selected as the overall moving direction Wd of the workpiece W. The overall moving direction Wd of the workpiece W may be displayed in the image display region 410. As described above, the image inspection device S (in particular, the inspection setting section 200) receives the setting of the overall moving direction Wd at the time of setting the passage mode. With this configuration, a matching result according to user's intention is obtained (details will be described later).

Note that, in a surveillance camera, a main monitoring target is a person. Thus, instead of assuming that all persons move in the same direction, in order to estimate in which direction each person moves or to track a person who comes out of the capturing field of view once and then returns again, the monitoring target is distinguished as “person a” and “person b” instead of “person”.

On the other hand, in the image inspection device S mainly used in an FA field, there is an assumption that all the workpieces W to be inspected move in the same direction. Thus, the overall moving direction Wd of the workpiece W is set in advance, and thus, the matching accuracy of the workpiece W between the frame images is improved.

However, the image inspection device S is not necessarily limited to the configuration in which the user manually sets the overall moving direction Wd of the workpiece W. For example, the image inspection device S may be configured to estimate the moving direction of the workpiece W by diverting the existing technology of the surveillance camera and automatically set the estimation result as the overall moving direction Wd of the workpiece W.

When the back button c2 is clicked, the screen returns to the mode selection screen 400b described above. On the other hand, when the forward button c3 is clicked, the process proceeds to the second process (master registration).

Note that, as illustrated in this drawing, in the first process (capturing setting), a live image (=moving image being captured) may be displayed in the image display region 410. In this case, the state display banner 411 may display a banner (for example, “Live”) indicating that a live image is being displayed.

In addition, although not explicitly illustrated in this drawing, in the first process (capturing setting), the capturing field of view, brightness of an image, focus, capturing interval (frame rate), and the like may be set.

In the second process (master registration), a master image selection screen 400d (a fourth row in the left column) is displayed. The master image selection screen 400d corresponds to step S13 in FIG. 4. In the operation region 420 of the master image selection screen 400d, for example, a live button d1, a history button d2, a file button d3, a back button d4, and a forward button d5 may be displayed.

When the live button d1 is clicked, the live image displayed in the image display region 410 at this point in time is registered as the master image. Note that, the master image can be registered from a driving history image (inspected image) by clicking the history button d2. In addition, the master image can be registered from a file image stored in a storage by clicking the file button d3. As described above, examples of a setting method for registering the master image include a method for registering from the live image, a method for registering from the driving history image, and a method for registering from the file image.

When the back button d4 is clicked, the process returns to the first process (capturing setting) described above. On the other hand, when the forward button d5 is clicked, the process proceeds to the third step (tool setting).

In the third process (tool setting), a tool setting screen 400e (a first row in a right column) is displayed. The tool setting screen 400e corresponds to step S14 in FIG. 4. In the operation region 420 of the tool setting screen 400e, for example, a square button e1, a circular button e2, a guidance e3, a learning start button e4, and a cancel button e5 may be displayed. In addition, a banner (for example, “TOOL”) indicating that the tool is being set may be displayed on the state display banner 411.

On the tool setting screen 400e, the workpiece W appearing in the registered master image is designated as the target region (so-called ROI) by setting a window e0. For example, when the square button e1 is clicked, the square window e0 is displayed in the image display region 410. When the circular button e2 is clicked, a circular window (not illustrated) is displayed in the image display region 410. Note that, in the guidance e3, a method for designating a target region or the like may be displayed.

The user can designate the target region by adjusting a position, a size, and an angle of the window e0 so as to surround the workpiece W appearing in the master image according to the guidance e3. Label information (class) may be added to the designated target region. A plurality of target regions may be designated. However, the user does not necessarily need to designate all target regions, and a part of the target regions may be automatically designated. The image inspection device S may have a function of automatically learning a state where the target region is rotated.

When the learning start button e4 is clicked after the target region is designated, the learning of the machine learning model (object detection model) used in the passage mode is started. On the other hand, when the cancel button e5 is clicked, the designation of the target region is canceled.

When the learning of the machine learning model is started, a learning progress screen 400f (a second row in the right column) is displayed. The learning progress screen 400f corresponds to step S15 in FIG. 4. The image inspection device S (in particular, the inspection setting section 200) extracts and stores a first feature amount (for example, a feature vector of the target region) corresponding to the image characteristic of the workpiece W from the learning image by inputting a learning image (master image) to the machine learning model as the learning of the machine learning model. In the present embodiment, the first feature amount corresponding to the image characteristic of the workpiece W is extracted and stored as the learning of the machine learning model, but the machine learning model may be configured to update the parameter so as to detect the workpiece W based on the image characteristic of the workpiece W.

Note that, a learning progress dialog f0 may be displayed on the learning progress screen 400f as illustrated in this drawing. In the learning progress dialog f0, for example, a learning progress bar f1 indicating a degree of progress (0% to 100%) is displayed.

When the learning of the machine learning model is finished, a passage line setting screen 400g (a third row in the right column) is displayed. The passage line setting screen 400g corresponds to step S16 in FIG. 4. In the operation region 420 of the passage line setting screen 400g, for example, an enable button g1, a disable button g2, a guidance g3, a back button g4, and a forward button g5 may be displayed.

The enable button g1 and the disable button g2 are used to enable and disable a conveyor termination mode (drop mode), respectively. The conveyor termination mode may be enabled, for example, in a case where it is desired to count the workpiece W dropped from the conveyor. When the enable button g1 is clicked, the conveyor termination mode is enabled. On the other hand, when the disable button g2 is clicked, the conveyor termination mode is disabled. Note that, in the guidance g3, an outline and a schematic diagram of the conveyor termination mode may be displayed.

In the image display region 410, a passage line g0 that divides a pre-passage region X1 and a post-passage region X2 of the workpiece W is displayed. That is, the detection range of the workpiece W is divided into the pre-passage region X1 and the post-passage region X2. When the conveyor termination mode is disabled, the passage line g0 is fixed at a center of the image display region 410. On the other hand, when the conveyor termination mode is enabled, the setting of the passage line g0 by the user is received. For example, the passage line g0 may be set in accordance with a termination of the conveyor in accordance with the guidance g3. With such a configuration, it is possible to arbitrarily determine the pre-passage region X1 and the post-passage region X2 according to the user's intention.

When the conveyor termination mode is disabled, counting-up is performed when the movement of the workpiece W across the passage line g0 is detected, that is, when the workpiece W detected in the pre-passage region X1 in a certain frame image is detected in the post-passage region X2 in a subsequent frame image. On the other hand, in a case where the conveyor termination mode is enabled, the disappearance of the workpiece W detected in the pre-passage region X1 in the post-passage region X2 is detected and counting-up is performed. That is, in the conveyor termination mode, the number of workpieces W falling down from the termination of the conveyor (workpieces W in a lower cage) is counted.

Therefore, when the conveyor termination mode is enabled, even though a situation occurs in which the passage line g0 is not set at the termination of the conveyor and the workpiece W beyond the passage line g0 has not yet dropped from the termination of the conveyor, a deviation does not occur between the count value of the workpieces W and the number of workpieces W actually entering the cage.

When the back button g4 is clicked, the process returns to the second process (master registration) described above. On the other hand, when the forward button g5 is clicked, the process proceeds to the fourth process (output assignment).

In the fourth process (output assignment), an output assignment screen 400h (a fourth row in the right column) is displayed. The output assignment screen 400h corresponds to step S17 in FIG. 4. In the operation region 420 of the output assignment screen 400h, for example, a pull-down menu h1 of each of output ports OUT1 to OUT8, a back button h2, and a finish button h3 may be displayed.

In the pull-down menu h1, a plurality of candidates is displayed as output contents of each of the output ports OUT1 to OUT8. In this drawing, a counting result (COUNT UP) of the workpiece W is selected as the output content of the output port OUT1. In addition, a busy detection result (BUSY) is selected as the output content of the output port OUT2. In addition, an error detection result (ERROR) is selected as the output content of the output port OUT3. In addition, all of the output ports OUT4 to OUT8 are unused (OFF). With this configuration, not only the counting result of the workpiece W but also various kinds of information such as a busy detection result and an error detection result can be output in multiple bits.

When the back button h2 is clicked, the process returns to the third process (tool setting) described above. On the other hand, when the finish button h3 is clicked, the setting work of the passage mode is finished.

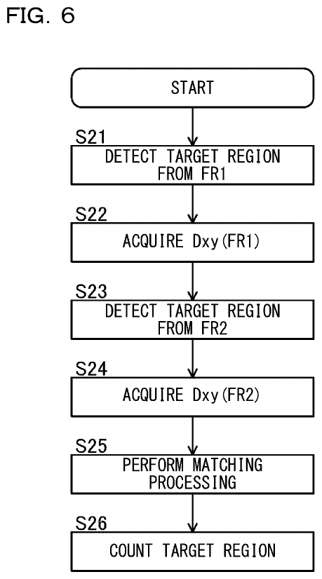

FIG. 6 is a diagram illustrating an execution flow of the passage count tool. Note that, an execution subject of this flow can be basically understood as the inspection execution section 300. In addition, the plurality of frame images FR sequentially generated by the image capturing unit 1 includes frame images FR1 and FR2.

When this flow is started, in step S21, the target region is detected from the frame image FR1 based on the image characteristic (first feature amount) of the workpiece W. For example, the inspection execution section 300 may detect the target region in which a second feature amount closest to the first feature amount is obtained from the frame image FR1 by inputting the frame image FR1 to the machine learning model (object detection model). As described above, in the configuration in which the target region is detected by using the machine learning model, the robustness against the change in the image characteristic is improved.

In step S22, positional information Dxy(FR1) of the target region detected in the frame image FR1 is acquired. In a case where a plurality of target regions is detected in the frame image FR1, pieces of positional information Dxy1(FR1), Dxy2(FR1), . . . , and Dxy*(FR1) corresponding to the target regions, respectively, are acquired. For example, the inspection execution section 300 may acquire the positional information Dxy(FR1) of the target region by comparing the first feature amount of the workpiece W with the second feature amount of each region in the frame image FR1.

In step S23, the target region is detected from the frame image FR2 based on the image characteristic (first feature amount) of the workpiece W. For example, the inspection execution section 300 may detect the target region in which the second feature amount closest to the first feature amount is obtained from the frame image FR2 by inputting the frame image FR2 to the machine learning model (object detection model). This point is similar to step S21 described above.

In step S24, the positional information Dxy(FR2) of the target region detected in the frame image FR2 is acquired. In a case where a plurality of target regions is detected in the frame image FR2, pieces of positional information Dxy1(FR2), Dxy2(FR2), . . . , and Dxy*(FR2) corresponding to the target regions are acquired. For example, the inspection execution section 300 may acquire the positional information Dxy(FR2) of the target region by comparing the first feature amount of the workpiece W with the second feature amount of the target region in the frame image FR2. This point is similar to step S21 described above.

In step S25, matching processing of the target region is performed between the frame image FR1 and the frame image FR2 based on the pieces of positional information Dxy(FR1) and Dxy(FR2) and the overall moving direction Wd of the workpiece W. The matching processing as used herein is performed as a pre-process of processing of detecting how the workpiece W is moving (so-called tracking processing).

In step S26, the target region is counted based on the result of the matching processing. For example, the inspection execution section 300 may count only the target region determined to be positioned in the pre-passage region X1 in the frame image FR1 and determined to be positioned in the post-passage region X2 in the frame image FR2 based on the result of the matching processing.

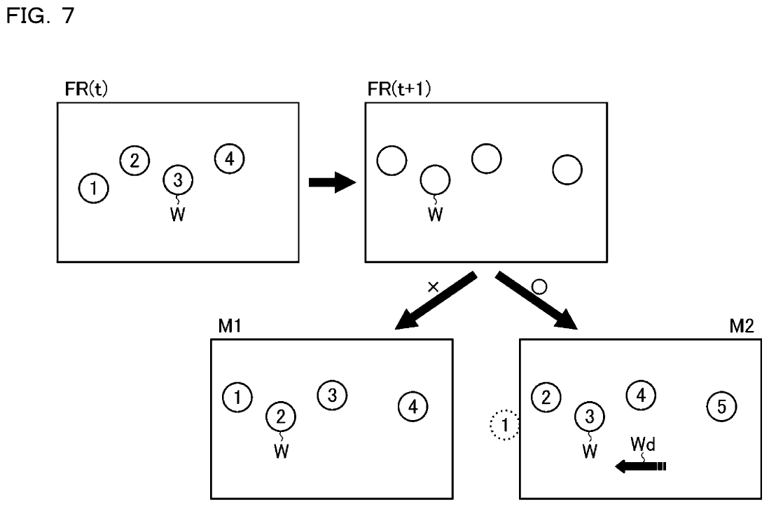

FIG. 7 is a conceptual diagram related to matching processing performed between a frame image FR(t) and a frame image FR(t+1).

In the frame image FR(t), four workpieces W are detected as the target regions (ROIs) described above, and ID1 to ID4 are sequentially assigned from the left to the right. Subsequently, in the frame image FR(t+1) captured after one frame, four workpieces W are also detected.

In the conventional tracking processing, a method for associating the same ID with detection results having a closest relative position between the frame image FR(t) and the frame image FR(t+1) is generally adopted. By using this method, as indicated by a matching result M1, ID1 to ID4 are also assigned to the four workpieces W appearing in the frame image FR(t+1) in order from left to right.

However, at a site where the image inspection device S is introduced, all the workpieces W mounted on the conveyor uniformly move along the overall moving direction Wd (from right to left in this drawing). That is, a state where the workpiece W positioned on a leftmost side in the frame image FR(t) is frame-out from a left end of the capturing field of view and a new workpiece W is frame-in from a right end of the capturing field of view appears in the frame image FR(t+1).

Therefore, for four workpieces W appearing in the frame image FR(t+1), the matching result M1 is an error, and as indicated by a matching result M2, ID2 to ID5 should be assigned in order from left to right. However, when the overall moving direction Wd of the workpiece W is not given, it is difficult to determine which of the matching results M1 and M2 is correct.

On the other hand, when the overall moving direction Wd of the workpiece W is set in advance by the user, a correct matching result M2 is obtained based on the positional information Dxy of the workpiece W and the overall moving direction Wd shown in each of the frame images FR(t) and FR(t+1). As a result, since the positional information Dxy of each of the plurality of workpieces W is accurately acquired based on the matching result M2, it is possible to reduce overlapping count and count omission of the workpieces W.

In addition, at a site where the image inspection device S is introduced, the conveyor often stops during operation. At this time, the workpiece W can move greatly differently before and after the conveyor is stopped. The conventional tracking processing cannot cope with such a case. On the other hand, when the overall moving direction Wd of the workpiece W is set as described above, it is possible to determine whether or not the conveyor is stopped by comparing the detection results of the target regions (ROI) in each of the plurality of frame images FR. Therefore, even in a case where the conveyor is stopped, the workpiece W can be correctly counted.

In addition, the inspection execution section 300 may detect an abnormal state and output a warning by comparing the detection results of the target regions (ROIs) in each of the plurality of frame images FR. Examples of the abnormal state include appearance (overdetection) or disappearance of a target region that suddenly occurs at a position other than a boundary of the capturing field of view (upstream end and downstream end in the overall moving direction Wd). Note that, the inspection execution section 300 may output a warning without delay at a point in time when the abnormal state is detected even in one frame. Alternatively, the inspection execution section 300 may wait for the warning output unless the abnormal state is detected in a plurality of frames. In addition, when the conveyor termination mode is enabled, the inspection execution section 300 may allow disappearance of the target region in the post-passage region X2. More specifically, when the conveyor termination mode is enabled, the inspection execution section 300 does not perform the warning output even in a case where the workpiece W detected in the pre-passage region X1 disappears in the post-passage region X2, and counts up when the workpiece W disappears from the post-passage region X2.

In the conveyor termination mode according to the present embodiment, the disappearance of the workpiece W from the post-passage region X2 is set as the condition of the counting-up, but the counting-up may be performed by the disappearance of the workpiece W from the pre-passage region X1. For example, even in a case where the workpiece W dropped from the conveyor termination is included in the capturing field of view, the workpiece W dropped from the conveyor termination can be counted with high accuracy by disposing the passage line g0 at the conveyor termination.

### Additional Learning

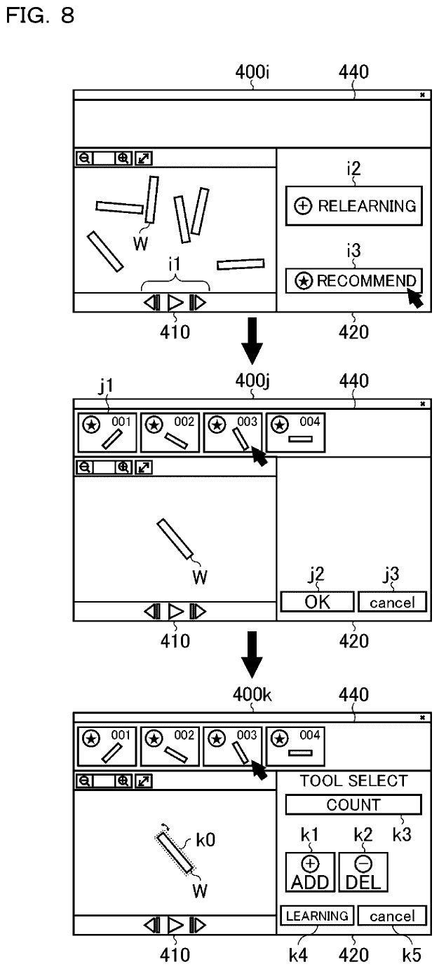

FIG. 8 is a diagram illustrating GUI transition of the additional learning in the driving mode (or at the time of test driving in the setting mode, and the same applies later). When the image inspection device S is in the driving mode, a driving screen 400i is displayed on the display device 4. The driving screen 400i may include, for example, a thumbnail display region 440 in addition to the image display region 410 and the operation region 420 described above.

In the image display region 410, for example, an image operation button i1 may be displayed. The image operation button i1 is operated when a frame image (for example, a driving history image including an inspected frame image) displayed in the image display region 410 is reproduced or paused, fast-rewound or fast-forwarded, and frame-rewound or frame-forwarded.

In the operation region 420, for example, an additional learning button i2 and a learning recommendation image button i3 are displayed. When the additional learning button i2 is clicked, the screen transitions to a tool setting screen for performing additional learning on the frame image displayed in the image display region 410 at this point in time (see, for example, the tool setting screen 400e described above or a tool setting screen 400k to be described below). When the learning recommendation image button i3 is clicked, the screen transitions to an image selection screen 400j.

A learning recommendation image j1 is displayed in the thumbnail display region 440 of the image selection screen 400j. As the learning recommendation image j1, for example, among the plurality of frame images FR, a frame image FR in a section in which an abnormal state is detected during the tracking processing described above may be picked up. In the learning recommendation image j1, there is a high possibility that a background is detected as the target region or the workpiece W is not detected as the target region. Thus, it can be said that the learning recommendation image j1 is suitable as a learning image for additionally learning the machine learning model (object detection model). Note that, the learning recommendation image j1 selected in the thumbnail display region 440 may be displayed in the image display region 410.

In the operation region 420 of the image selection screen 400j, for example, an OK button j2 and a cancel button j3 are displayed. When the OK button j2 is clicked, the screen transitions to the tool setting screen 400k for performing additional learning for the learning recommendation image j1 displayed in the image display region 410 at this point in time. That is, the inspection setting section 200 receives the learning recommendation image j1 as the learning image for the additional learning. On the other hand, when the cancel button j3 is clicked, a selection state of the learning recommendation image j1 is canceled.

In the operation region 420 of the tool setting screen 400k, for example, an add button k1, a delete button k2, a tool selection box k3, a learning start button k4, and a cancel button k5 are displayed. When the add button k1 is clicked, one window k0 is added to the image display region 410. The user can designate the target region by adjusting a position, a size, and an angle of the window k0 so as to surround the workpiece W. On the other hand, when the delete button k2 is clicked, the window k0 being selected is deleted. As described above, the inspection setting section 200 can select the learning image for additional learning from the inspection result screen displaying the frame image FR and receive the setting of the window k0.

The tool selection box k3 is used to select a tool for performing additional learning in a case where there is a plurality of tools. That is, it is possible to perform additional learning on the plurality of tools from one frame image.

When the learning start button k4 is clicked after the target region is designated, the additional learning of the machine learning model (object detection model) used in the passage mode is started. On the other hand, when the cancel button k5 is clicked, the designation of the target region is canceled.

### Others

Note that, in addition to the embodiment, various modifications can be made to various technical characteristics disclosed in the present specification without departing from the spirit of the technical creation. That is, it should be considered that the embodiment is illustrative in all respects and not restrictive. In addition, the technical scope of the invention is defined by the claims, and should be understood to include all modifications falling within the meaning and scope equivalent to the claims.

What is claimed is:

1. An image inspection device comprising:
an image capturing section that continuously captures a capturing field of view to generate a plurality of frame images aligned in time series;
an inspection execution section that executes inspection processing of an object appearing in the plurality of frame images to output an inspection result; and
an inspection setting section that performs setting of the inspection execution section,
wherein the inspection setting section receives setting of a window for a learning image on which the object appears, and
the inspection execution section detects target regions from the plurality of frame images based on the learning image and the window set for the learning image, acquires first positional information of the target region detected in a first frame image and second positional information of the target region detected in a second frame image, performs matching processing of the target region between the first frame image and the second frame image based on the first positional information, the second positional information, and an overall moving direction of the object, and counts the object based on a result of the matching processing.

2. The image inspection device according to claim 1,
wherein the inspection setting section stores an image characteristic of the object based on the setting of the window, and
the inspection execution section detects the target regions from the plurality of frame images based on the image characteristic of the object.

3. The image inspection device according to claim 2,
wherein the inspection setting section extracts and stores a first feature amount corresponding to the image characteristic of the object from the learning image by inputting the learning image to a machine learning model, and
the inspection execution section detects the target region in which a second feature amount closest to the first feature amount is obtained from the frame image by inputting the frame image to the machine learning model.

4. The image inspection device according to claim 1, wherein the inspection setting section receives setting of the overall moving direction.

5. The image inspection device according to claim 1,
wherein a detection range of the object is divided into a pre-passage region and a post-passage region, and
the inspection execution section counts only the target region determined to be positioned in the pre-passage region in the first frame image and determined to be positioned in the post-passage region in the second frame image, based on the result of the matching processing.

6. The image inspection device according to claim 5, wherein the inspection setting section receives setting of a passage line that divides the pre-passage region and the post-passage region.

7. The image inspection device according to claim 5,
wherein the inspection setting section receives setting for allowing disappearance of the target region in the post-passage region, and
the inspection execution section counts the target region even though the target region disappears in the post-passage region in a case where the inspection setting section receives the setting for allowing disappearance of the target region.

8. The image inspection device according to claim 1, wherein the inspection execution section detects an abnormal state by comparing detection results of the target regions in the plurality of frame images and outputs a warning.

9. The image inspection device according to claim 8, wherein the inspection setting section receives, as a learning recommendation image, the frame image in a section in which the abnormal state is detected, among the plurality of frame images.

10. The image inspection device according to claim 1, wherein the inspection setting section selects the learning image for additional learning from an inspection result screen and receives the setting of the window, the inspection result screen displaying the frame image.
